(19) United States
(12) Patent Application Publication
(10) Pub. No.: US 2015/0117155 A1
(43) Pub. Date: Apr. 30, 2015

(54) ELECTRIC ACOUSTIC WINDOWS WITH OPTIONAL SOUND SHIELDING

(71) Applicant: Electronics and Telecommunications Research Institute, Daejeon (KR)

(72) Inventors: Dae Young JANG, Daejeon (KR); Jeong Il SEO, Daejeon (KR); Kyeong Ok KANG, Daejeon (KR)

(21) Appl. No.: 14/303,241

(22) Filed: Jun. 12, 2014

(30) Foreign Application Priority Data
Oct. 29, 2013 (KR) 10-2013-0129500

(51) Int. Cl. G10K 11/18

(52) U.S. Cl. CPC G10K 11/18
USPC 367/135

(57) ABSTRACT

Provided is an acoustic processing apparatus capable of optional sound shielding that may selectively control a sound entering an acoustically shielded interior of a building or a vehicle and form a pleasant acoustic environment, including an acoustic receiver to obtain at least one external acoustic signal, an acoustic signal processor to process the obtained external acoustic signal, and a player to internally play the processed acoustic signal through at least one speaker.

### CROSS-REFERENCE TO RELATED APPLICATION

This application claims the priority benefit of Korean Patent Application No. 10-2013-0129500, filed on Oct. 29, 2013, in the Korean Intellectual Property Office, the disclosure of which is incorporated herein by reference.

### BACKGROUND

1. Field of the Invention

The present invention relates to an acoustic processing apparatus that may selectively control a sound entering an acoustically shielded interior of a building or a vehicle, and form a pleasant acoustic environment.

2. Description of the Related Art

A variety of physical and electronic methods are used to reduce noise entering a separate indoor space of a vehicle or a building. A physical method may involve a long-standing conventional method of blocking all sounds from entering by mainly using a sound insulator. In most cases, applying such a method may require windows to be opened for air circulation and communication and thus, opening and closing the windows may be necessary as circumstances dictate.

For example, Korean Patent Publication No. 10-2007-0066788 entitled “Method and Apparatus for Controlling Sound Field in Car A/V System” discloses a method of compensating for a sound pressure characteristic of a sound source based on an increase/decrease in information on a register zone of noise generated inside of a vehicle and ensuring an output of a higher-quality sound source than an automobile sound system having variables that may affect a sound, and a method that may contribute to safe driving without a need to adjust an audio volume based on a surrounding environment. However, although the aforementioned disclosure may adjust a volume of the audio and visual (A/V) system of the vehicle based on a characteristic of noise generated inside of the vehicle, a sound may not be selectively played and controlled.

Recently, an electronic method is being used as an alternative. The electronic method may include measuring an acoustic signal entering from an external environment, artificially generating a signal that may offset the acoustic signal, and eliminating the entering acoustic signal. However, a primary focus of the electronic method may be on eliminating the entering acoustic signal and may not selectively control entry of the acoustic signal and thus, consideration may not be given to a pleasant internal acoustic environment. Accordingly, a method differing from the noise elimination and may be able to verify a sound from an exterior of a separate space may be required.

### SUMMARY

Exemplary embodiments of the present invention disclose an electronic acoustic processing apparatus that may control a characteristic of an acoustic signal transferred using an electronic method to interactively transfer external and internal acoustic information of a separate space.

According to an aspect of the present invention, there is provided an acoustic processing apparatus including an acoustic receiver to obtain at least one external acoustic signal, an acoustic signal processor to process the obtained external acoustic signal, and a player to internally play the processed acoustic signal through at least one speaker.

The acoustic signal processor may extract a selected acoustic signal from the obtained external acoustic signal, and the player may exclusively play the selected acoustic signal.

The acoustic signal processor may eliminate an unselected acoustic signal from the obtained external acoustic signal, and the player may play an acoustic signal from which the unselected acoustic signal is eliminated.

The acoustic receiver may include a plurality of acoustic sensors provided in a form of an array or a distributed microphone network, and the plurality of the acoustic sensors may obtain an external sound field. The player may include a plurality of speakers, and the plurality of the speakers may play the external sound field internally.

The acoustic processing apparatus may transmit an acoustic signal from an exterior to an interior, as opposed to an interior to an exterior.

The acoustic processing apparatus may further include a storage to store the external acoustic signal.

The acoustic signal processor may process, using the preselected acoustic signal stored in the storage, a sound of the preselected acoustic signal to appear to be generated externally.

The acoustic signal processor may include an acoustic signal analyzer to extract at least one object signal from the external acoustic signal obtained by the sound receiver, an object selection controller to exclusively extract a selected acoustic signal from the extracted object signal, and an object sound synthesizer to synthesize the selected acoustic signal and control the synthesized acoustic signal to be played through the at least one speaker.

According to another aspect of the present invention, there is provided an acoustic processing apparatus including an acoustic receiver to be provided at a first location and a second location that are divided by a sound shielding window and to obtain at least one acoustic signal from the first location, an acoustic signal processor to process the obtained acoustic signal, and a player to be provided at the second location and play the processed acoustic signal at the second location.

The acoustic processing apparatus may further include a second acoustic receiver to obtain at least one second acoustic signal from the second location, and a second player to be provided at the first location. The acoustic signal processor may process the obtained second acoustic signal, and the second player may play the processed second acoustic signal at the first location.

The acoustic signal processor may extract a selected acoustic signal from the acoustic signal obtained from the first location, and the player may exclusively play the selected acoustic signal at the second location.

The acoustic signal processor may include an acoustic signal analyzer to extract at least one object signal from the acoustic signal obtained from the first location by the acoustic receiver, an object selection controller to exclusively extract a selected acoustic signal from the extracted object signal, and an object sound synthesizer to synthesize the selected acoustic signal and control the synthesized acoustic signal to be played by the player.

The acoustic receiver may include a plurality of acoustic sensors provided in a form of an array etc. and obtain a sound field of the first location. The player may include a plurality of speakers and play the obtained sound field of the first location at the second location.

According to still another aspect of the present invention, there is provided an acoustic processing apparatus including an acoustic receiver to obtain an external acoustic signal from an exterior and an interior that are separated based on a body of a vehicle, an acoustic signal processor to process the obtained acoustic signal, and a player to internally play the processed acoustic signal through a plurality of speakers provided in the interior.

The acoustic processing apparatus may further include a storage to store a preselected announcement sound. The acoustic signal processor may generate an audio signal in which the preselected announcement sound stored in the storage and the processed acoustic signal are synthesized and control the audio signal to be played by the player.

When the announcement sound indicates a left turn, the player may play the announcement sound to appear to be heard from a left side of a driver of the vehicle. When the announcement sound indicates a right turn, the player may play the announcement sound to appear to be heard from a right side of the driver of the vehicle.

The acoustic signal processor may extract a selected acoustic signal from the external acoustic signal, and the player may exclusively play the selected acoustic signal internally.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of an acoustic processing apparatus according to an embodiment of the present invention;

FIG. 2 is a diagram illustrating operation of an acoustic processing apparatus according to an embodiment of the present invention;

FIGS. 3A and 3B are diagrams illustrating operation of an acoustic processing apparatus by a sound shielding wall according to an embodiment of the present invention;

FIG. 4 illustrates operation of an acoustic processing apparatus in a separate space according to an embodiment of the present invention;

FIG. 5 is a diagram illustrating operation of an acoustic processing apparatus to which a storage is added according to an embodiment of the present invention;

FIG. 6 illustrates an acoustic processing apparatus interworking with a navigation device according to an embodiment of the present invention; and

FIG. 7 is a flowchart illustrating an acoustic processing method of an acoustic processing apparatus according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

Conventionally, a physical window may be used in a closed space to transfer a sound externally and internally. However, the physical window may allow an undesired external sound, odors, temperature fluctuations, and dust to enter an interior of the closed space along with a desired sound. Hereinafter, technology for selectively controlling a sound using an electronic characteristic will be described.

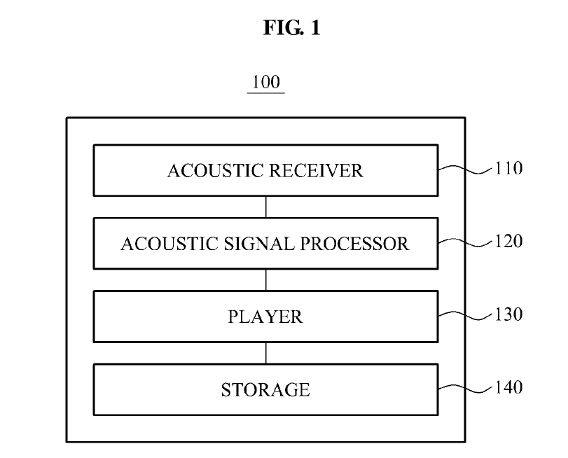

FIG. 1 is a block diagram illustrating a configuration of an acoustic processing apparatus 100 according to an embodiment of the present invention.

The acoustic processing apparatus 100 may include an acoustic receiver 110, an acoustic signal processor 120, a player 130, and a storage 140. The acoustic processing apparatus 100 may apply an electronic method to obtain an external sound, process the obtained external sound, and internally play the processed sound through a speaker and thus, the external sound may be heard in a physically closed space.

The acoustic receiver 110 may obtain at least one external acoustic signal. The acoustic receiver 110 may include a plurality of acoustic sensors provided in a form of an array etc., and the acoustic sensors may obtain an external sound field. Here, the sound field may refer to a field in which a sound is present and also to a field in which a sound is generated or resonates.

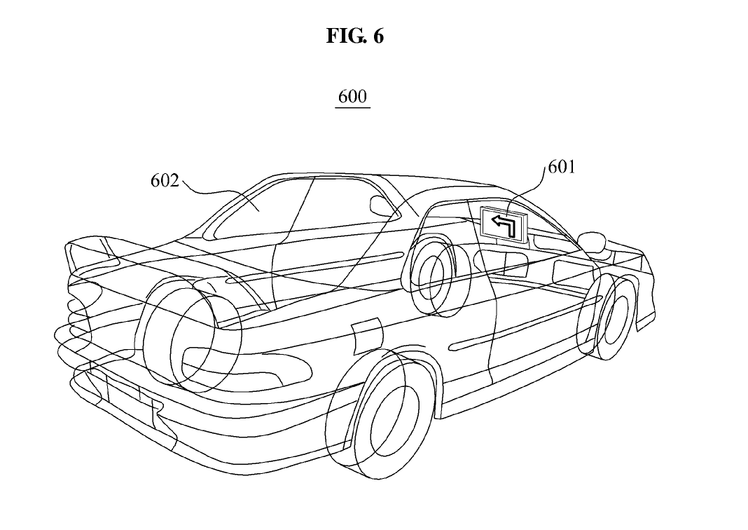

The acoustic receiver 110 may be provided at a first location of the first location and a second location that are divided by a sound shielding wall, and obtain at least one first acoustic signal from the first location and at least one second acoustic signal from the second location. For example, referring to FIG. 6, the acoustic receiver 110 may obtain an acoustic signal from an exterior of the exterior and an interior that are separated by a body of a vehicle.

The acoustic signal processor 120 may process the acoustic signal obtained by the acoustic receiver 110. More particularly, the acoustic signal processor 120 may extract a selected acoustic signal from the obtained external acoustic signal, or eliminate an unselected acoustic signal from the obtained external acoustic signal.

The acoustic signal processor 120 may extract at least one object signal from the obtained external acoustic signal, and exclusively extract a selected acoustic signal from the extracted object signal. Here, the acoustic signal processor 120 may synthesize the selected acoustic signal and control the synthesized acoustic signal to be played through at least one speaker. Also, the acoustic signal processor 120 may use a preselected acoustic signal stored in the storage 140 and process a sound of the preselected acoustic signal to appear to be generated externally.

The acoustic signal processor 120 may synthesize a preselected announcement sound stored in the storage 140 with the processed acoustic signal to generate a synthesized audio signal and control the audio signal to be played by the player 130.

The player 130 may internally play the acoustic signal processed by the acoustic signal processor 120 through the at least one speaker. The player 130 may exclusively play the selected acoustic signal and the acoustic signal from which the unselected acoustic signal is eliminated. Here, the player 130 may use a plurality of speakers provided in a form of an array or a multichannel speaker to play the acoustic signal. The player 130 may play the processed acoustic signal in an upwardly and downwardly balanced manner using the array form. A general speaker may apply a point sound source and thus, energy may be reduced over a distance in a proportion similar to diffusion of light. Conversely, the speaker provided in the form of the array may apply a principle that wave sources very close to one another operate as a single wave front.

The player 130 may be provided at the second location and play the processed acoustic signal at the second location. Here, the acoustic signal processor 120 may extract a selected acoustic signal from an acoustic signal obtained from the first location, and the player 130 may exclusively play the selected acoustic signal at the second location. Similarly, the acoustic signal processor 120 may extract a selected acoustic signal from an acoustic signal obtained from the second location, and the player 130 may be provided at the first location to exclusively play the processed acoustic signal at the first location.

The player 130 may include a plurality of speakers and play a sound field of the first location at the second location. More particularly, when an announcement sound indicates a left turn, the player 130 may play the announcement sound to appear to be heard from a left side of the driver. When an announcement sound indicates a right turn, the player 130 may play the announcement sound to appear to be heard from a right side of the driver.

The storage 140 may store an obtained external acoustic signal. Also, the storage 140 may store a preselected acoustic signal and an arbitrary acoustic signal. For example, a stored sound may be used to simulate a presence of an arbitrary sound in an exterior. A security/surveillance system may be provided by storing an external sound based on acoustic information. Also, external conditions may be intelligently monitored using a function of tracing a learned sound, and a result of the monitoring may be provided internally.

According to an embodiment, the acoustic processing apparatus 100 may interwork with a navigation device and a stored database to transmit a sound.

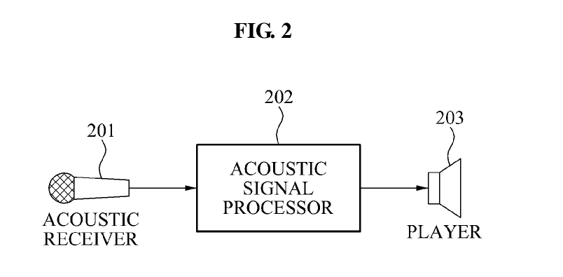

FIG. 2 is a diagram illustrating operation of an acoustic processing apparatus according to an embodiment of the present invention.

Referring to FIG. 2, the acoustic processing apparatus may include an acoustic receiver 201, an acoustic signal processor 202, and a player 203. The acoustic processing apparatus may apply an electronic method to obtain a sound, process the obtained sound, and play the processed sound through a speaker and thus, the sound may be controlled.

The acoustic receiver 201 may obtain at least one acoustic signal, and include a plurality of acoustic sensors provided in a form of an array etc. The acoustic sensors may obtain an external sound field.

The acoustic signal processor 202 may process the acoustic signal obtained by the acoustic receiver 201. More particularly, the acoustic receiver 201 may extract a selected acoustic signal from the obtained acoustic signal, and eliminate an unselected acoustic signal from the obtained acoustic signal. Here, the acoustic signal processor 202 may extract at least one object signal from the acoustic signal obtained by the acoustic receiver 201, extract only a selected acoustic signal from the extracted object signal, synthesize the selected acoustic signal, and control the synthesized acoustic signal to be played through at least one speaker.

The player 203 may play the acoustic signal processed by the acoustic signal processor 202 through the at least one speaker.

The acoustic processing apparatus may apply the electronic method and transmit acoustic information through the acoustic signal processor 202, without requiring a separate space blocked by, for example, a sound shielding wall.

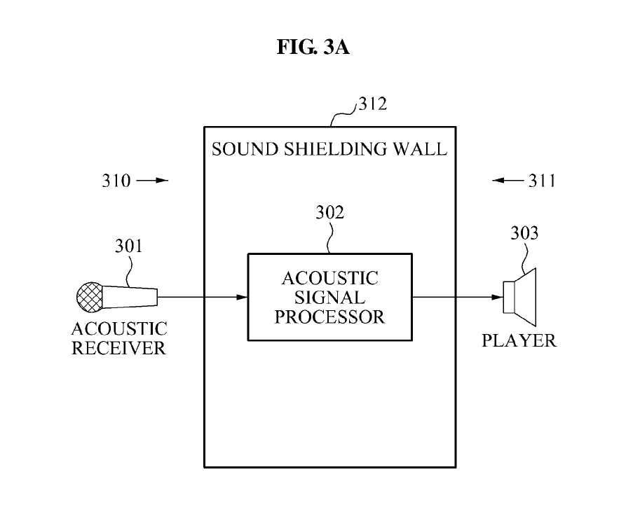

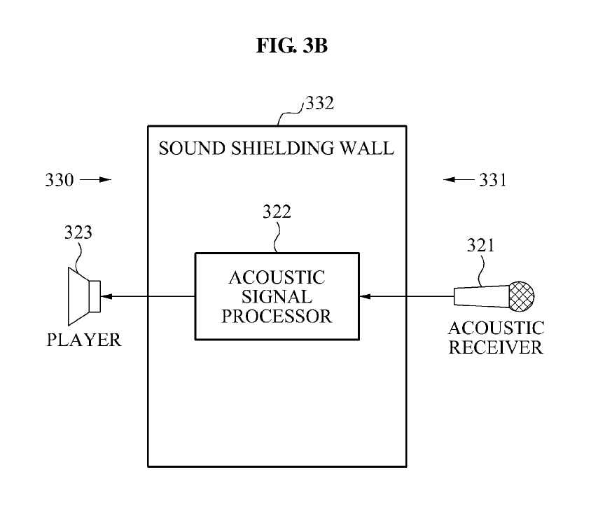

FIGS. 3A and 3B are diagrams illustrating operation of an acoustic processing apparatus by a sound shielding wall according to an embodiment of the present invention.

Referring to FIGS. 3A and 3B, a first location and a second location may be separated by the sound shielding wall. As illustrated in FIG. 2, the acoustic processing apparatus may include an acoustic receiver, an acoustic signal processor, and a player.

FIG. 3A illustrates the acoustic processing apparatus that may obtain at least one acoustic signal from a first location 310 by a sound shielding wall 312.

An acoustic receiver 301 may be provided at the first location 310 and the second location 311 that are separated by the sound shielding wall 312, and may obtain at least one acoustic signal from the first location 310.

The acoustic signal processor 302 may process the obtained acoustic signal. For example, when a sound of children, a sound of construction, and a sound of nature are received by the acoustic receiver 301 from the first location 310, the acoustic signal processor 302 may select and extract only the sound of children and control a player 303 to play the selected and extracted sound of children.

The player 303 may be provided at the second location 311 and play the processed acoustic signal at the second location 311. Here, the player 303 may play a digital signal converted by the acoustic signal processor 302 through an outputting device, for example, a speaker, at the second location 311.

FIG. 3B illustrates the acoustic processing apparatus that may obtain at least one acoustic signal from a second location 331 by a sound shielding wall 332.

An acoustic receiver 321 may obtain at least one second acoustic signal from the second location 331 of a first location 330 and the second location 331 separated by the sound shielding wall 332.

An acoustic signal processor 322 may process the obtained second acoustic signal. For example, when a sound of children, a sound of construction, and a sound of nature are received by the acoustic receiver 321 from the second location 331, the acoustic signal processor 322 may select and extract only the sound of nature and control the player 323 to play the selected and extracted sound of nature.

The player 323 may play the processed second acoustic signal at the first location 330. Here, the player 323 may play the acoustic signal selected and extracted by the acoustic signal processor 302 through an outputting device, for example, a speaker, at the first location 330.

The acoustic processing apparatus may process a sound based on a location separated by the sound shielding wall and thus, the sound may be bilaterally played based on a processed sound direction.

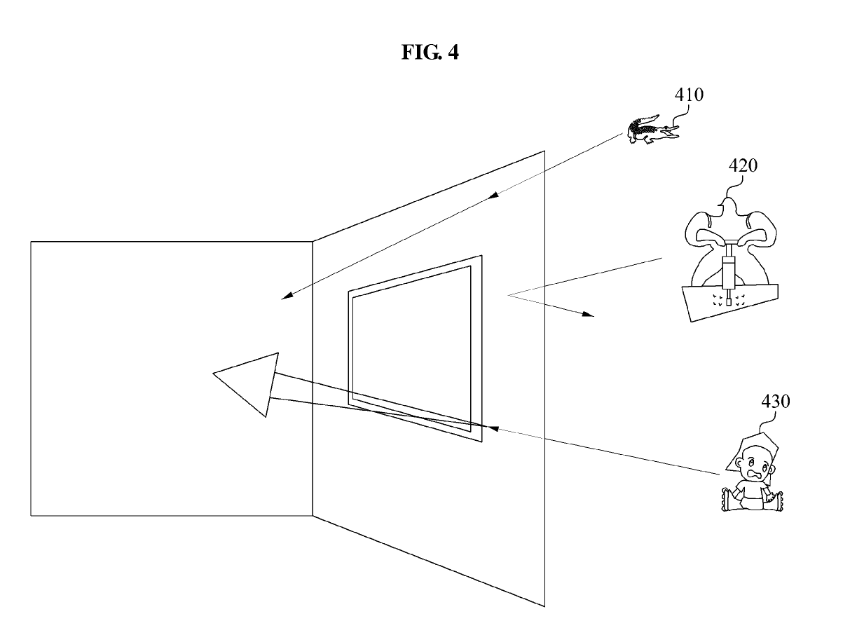

FIG. 4 illustrates operation of an acoustic processing apparatus in a separate space according to an embodiment of the present invention.

FIG. 4 illustrates an example of the separate space blocked by a wall.

The acoustic processing apparatus may selectively control sounds of both sides of the wall by applying an electronic acoustic method. For example, when a sound of a bird 410, a sound of a construction site 420, and a sound of children 430 are present in an exterior of the separate space, the acoustic processing apparatus may have functions of allowing a desired sound, for example, the sound of the bird 410, to be transmitted to an interior of the separate space, blocking an undesired sound, for example, the sound of the construction site 420, and converting the sound of children 430 so that information may be sufficiently transmitted.

The acoustic processing apparatus according to example embodiments may pass a desired sound through appropriate signal processing and form a pleasant acoustic environment.

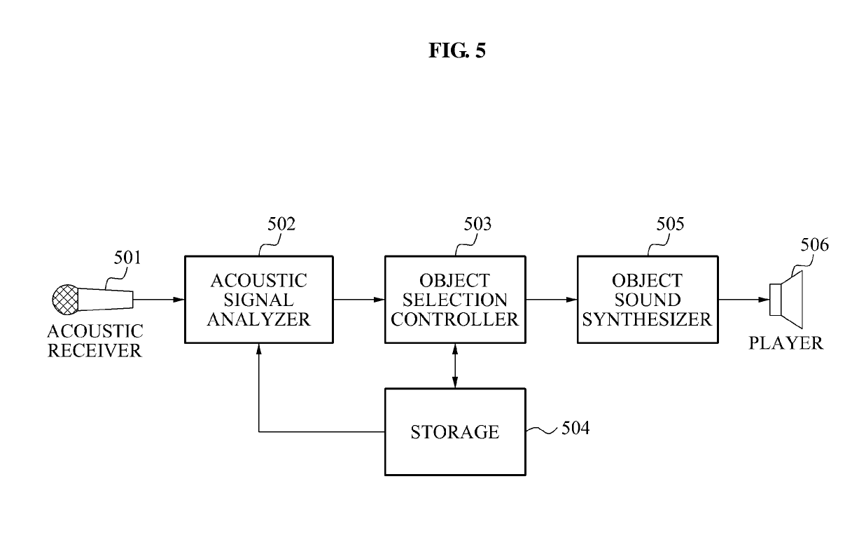

FIG. 5 is a diagram illustrating operation of an acoustic processing apparatus to which a storage 504 is added according to an embodiment of the present invention.

FIG. 5 illustrates a detailed configuration of an acoustic signal processor of the acoustic processing apparatus. The acoustic signal processor may include an acoustic signal analyzer 502, an object selection controller 503, and an object acoustic synthesizer 505.

An acoustic receiver 501 of the acoustic processing apparatus may obtain at least one external acoustic signal and extract at least one object signal from the obtained acoustic signal by the acoustic signal analyzer 502. The object selection controller 503 may extract only a selected acoustic signal from the extracted object signal. The object acoustic synthesizer 505 may synthesize the selected acoustic signal and control the acoustic signal to be played through at least one speaker.

The storage 504 may store an obtained external acoustic signal and a preselected acoustic signal. More particularly, the storage 504 may store the preselected acoustic signal and an arbitrary acoustic signal. For example, the acoustic processing apparatus may play a sound that is not generated externally to simulate the sound to be heard from an exterior using the sound stored in the storage 504 in order to enhance a refreshing feeling. Also, a security/surveillance system may be constructed based on acoustic information by storing an external sound. Thus, when an intruder is detected in an interior, a siren may be sounded externally to give an appearance of police officers arriving. Also, the acoustic processing apparatus may intelligently monitor an external situation using a function of tracing a learned sound and inform the interior of the monitored situation.

FIG. 6 illustrates an acoustic processing apparatus interworking with a navigation device 601 of a vehicle 600 according to an embodiment of the present invention.

As shown in FIG. 6, the acoustic processing apparatus may be an electric acoustic window 602. The electric acoustic window 602 may selectively transmit an externally generated sound to an interior of the vehicle 600. The acoustic processing apparatus may interwork with the navigation device 601 of the vehicle 600 and allow an announcement sound to be played from a progressing direction through a speaker. For example, although multiple speakers are present in a front side, and absent from a left or a right side, an announcement sound indicating a right turn may appear to be heard at the right side of a driver of the vehicle 600, and an announcement sound indicating a left turn may appear to be heard at the left side of the driver of the vehicle 600.

Accordingly, the acoustic processing apparatus may allow the driver to intuitively perceive a direction of progress of the vehicle 600 when the driver is in a difficult situation checking the navigation device 601. For example, when a sharp curve, a surrounding geographical feature, or a landmark to be announced is present, intuitive information may be transmitted to the driver through a voice announcement having directional information processed by acoustic signal processing.

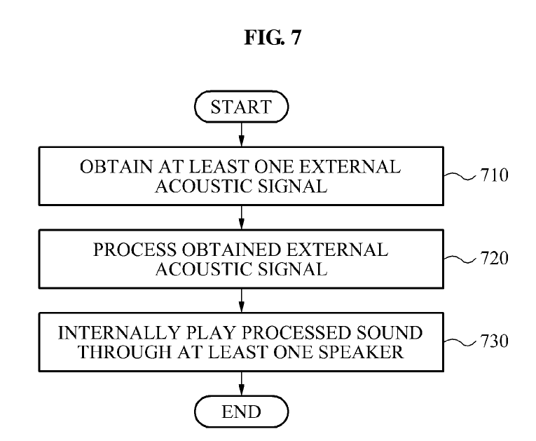

FIG. 7 is a flowchart illustrating an acoustic processing method of an acoustic processing apparatus according to an embodiment of the present invention.

The acoustic processing method may be performed by the acoustic processing apparatus and a detailed description of the acoustic processing apparatus is provided with reference to FIGS. 1 through 6.

In operation 710, the acoustic processing apparatus may obtain at least one external acoustic signal. Here, an acoustic receiver may include a plurality of acoustic sensors provided in a form of an array etc., and the acoustic sensors may obtain an external sound field.

In operation 720, the acoustic processing apparatus may process the obtained external acoustic signal. Here, the acoustic processing apparatus may extract at least one object signal from the obtained external acoustic signal, select at least one acoustic signal from among the extracted object signal, and synthesize a desired acoustic signal to be played.

In operation 730, the acoustic processing apparatus may internally play the processed acoustic signal through at least one speaker. Here, the acoustic processing apparatus may exclusively play the selected acoustic signal internally.

According to an embodiment, a perspective different from noise elimination may be needed to consider an external sound of a separate space. Here, a window and a combination of a microphone and a speaker may be used to transmit the sound.

Also, an advanced acoustic processing technology may provide a method of analyzing and separating an independent object acoustic signal from an electric acoustic signal input through a microphone, and the technology may enable elimination and extraction of an arbitrary object acoustic signal.

A sound shielding wall described herein may theoretically refer to a gap between two different spaces or be used as a means of remote monitoring and remote experience through remote communications. Also, an electronic acoustic window may provide an audiovisual function through interworking with an image signal and an image display.

According to embodiments of the present invention, combining an external and an internal acoustic transfer route with an electric method may enable an external sound to be to selectively transmitted through acoustic signal processing and thus, an obtained external acoustic signal may be analyzed to be used for various functions, for example, electric acoustic windows, security/surveillance, and safety. Such functions may require the electric method and be effectively altered by software and thus, improved functions may be simply applied.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An acoustic processing apparatus, comprising:
an acoustic receiver to obtain at least one external acoustic signal;
an acoustic signal processor to process the obtained external acoustic signal; and
a player to internally play the processed acoustic signal through at least one speaker.

2. The apparatus of claim 1, wherein the acoustic signal processor extracts a selected acoustic signal from the obtained external acoustic signal, and
wherein the player exclusively plays the selected acoustic signal.

3. The apparatus of claim 1, wherein the acoustic signal processor eliminates an unselected acoustic signal from the obtained external acoustic signal, and
wherein the player plays an acoustic signal from which the unselected acoustic signal is eliminated.

4. The apparatus of claim 1, wherein the acoustic receiver comprises a plurality of acoustic sensors provided in a form of an array or a distributed microphone network,
wherein the plurality of the acoustic sensors obtains an external sound field,
wherein the player comprises a plurality of speakers, and
wherein the plurality of the speakers plays the external sound field internally.

5. The apparatus of claim 1, wherein the acoustic processing apparatus transmits an acoustic signal from an exterior to an interior, as opposed to an interior to an exterior.

6. The apparatus of claim 1, further comprising:
a storage to store the external acoustic signal.

7. The apparatus of claim 1, further comprising:
a storage to store a preselected acoustic signal,
wherein the acoustic signal processor processes, using the preselected acoustic signal stored in the storage, a sound of the preselected acoustic signal to appear to be generated externally.

8. The apparatus of claim 1, wherein the acoustic signal processor comprises:
an acoustic signal analyzer to extract at least one object signal from the external acoustic signal obtained by the acoustic receiver;
an object selection controller to exclusively extract a selected acoustic signal from the extracted object signal; and
an object sound synthesizer to synthesize the selected acoustic signal and control the synthesized acoustic signal to be played through the at least one speaker.

9. An acoustic processing apparatus, comprising:
an acoustic receiver to be provided at a first location and a second location divided by a sound shielding window and to obtain at least one acoustic signal from the first location;
an acoustic signal processor to process the obtained acoustic signal; and
a player to be provided at the second location and play the processed acoustic signal at the second location.

10. The apparatus of claim 9, further comprising:
a second acoustic receiver to obtain at least one second acoustic signal from the second location; and
a second player to be provided at the first location,
wherein the acoustic signal processor processes the obtained second acoustic signal, and
wherein the second player plays the processed second acoustic signal at the first location.

11. The apparatus of claim 9, wherein the acoustic signal processor extracts a selected acoustic signal from the acoustic signal obtained from the first location, and
wherein the player exclusively plays the selected acoustic signal at the second location.

12. The apparatus of claim 9, wherein the acoustic signal processor comprises:
an acoustic signal analyzer to extract at least one object signal from the acoustic signal obtained from the first location by the acoustic receiver;
an object selection controller to exclusively extract a selected acoustic signal from the extracted object signal; and
an object sound synthesizer to synthesize the selected acoustic signal and control the synthesized acoustic signal to be played by the player.

13. The apparatus of claim 9, wherein the acoustic receiver comprises a plurality of acoustic sensors provided in a form of an array or a distributed microphone network and obtains a sound field of the first location, and
wherein the player comprises a plurality of speakers and plays the obtained sound field of the first location at the second location.

14. An acoustic processing apparatus, comprising:
an acoustic receiver to obtain an external acoustic signal from an exterior and an interior separated based on a body of a vehicle;
an acoustic signal processor to process the obtained acoustic signal; and
a player to internally play the processed acoustic signal through a plurality of speakers provided in the interior.

15. The apparatus of claim 14, further comprising:
a storage to store a preselected announcement sound,
wherein the acoustic signal processor generates an audio signal in which the preselected announcement sound stored in the storage and the processed acoustic signal are synthesized and controls the audio signal to be played by the player.

16. The apparatus of claim 15, wherein when the announcement sound indicates a left turn, the player plays the announcement sound to appear to be heard from a left side of a driver of the vehicle, and
wherein when the announcement sound indicates a right turn, the player plays the announcement sound to appear to be heard from a right side of the driver of the vehicle.

17. The apparatus of claim 14, wherein the acoustic signal processor extracts a selected acoustic signal from the external acoustic signal, and
wherein the player exclusively plays the selected acoustic signal internally.
